(19) United States
(12) Patent Application Publication
(10) Pub. No.: US 2003/0101114 A1
(43) Pub. Date: May 29, 2003

(54) System and method for collecting and analyzing tax reporting surveys

(76) Inventors: Janine L. Delapass, Plano, TX (US); Linda G. Flaming, Dallas, TX (US); Christopher F. Muckey, Richardson, TX (US)

Correspondence Address: Baker Botts L.L.P., Suite 600, 2001 Ross Avenue, Dallas, TX, 75201-2980, US

(21) Appl. No.: 10/021,197

(22) Filed: Nov. 29, 2001

(51) Int. Cl. G06F 17/60

(52) U.S. Cl. 705/31; 705/10

(57) ABSTRACT

A method for calculating tax credit information includes providing an on-line reporting form to a plurality of users. Information regarding allocation of financial resources regarding one or more projects associated with more than one of the plurality of users is collected from the more than one of the plurality of users. Tax credit information is calculated based upon the allocation of financial resources regarding the one or more projects. In accordance with the particular embodiment, at least some of the information collected from the more than one of the plurality of users is automatically verified while the information is being input by the more than one of the plurality of users. The automatic verification may include comparing information with stored data within one or more database.

### TECHNICAL FIELD OF THE INVENTION

This invention relates in general to on-line surveys and, more particularly, to a system and method for collecting and analyzing tax reporting surveys.

### BACKGROUND OF THE INVENTION

Research and Experimentation (R&E) Tax Credits are available to companies and organizations who commit time, money and resources to technological advances. Many large, high-technology companies receive substantial tax credits for research and experimentation in particular fields. In order to determine the cumulative tax credit(s) available to a company or organization, information must be collected from various groups or cost centers within an organization, regarding the amount of time, money and/or resources expended on such programs. Distributing, collecting and analyzing such information requires a substantial amount of labor and resources. Furthermore, a significant amount of backup documentation must be collected and submitted to the government, or stored for use in justifying the amount of the overall tax credit.

Previous methods for collecting such data include widespread distribution of hardcopy forms to be distributed to various employees that may be conducting qualifying activities. Such forms are filled out by many employees and submitted to tax professionals for review. It is not uncommon for the review to reveal errors by the “client” that filled out the form. Similarly, the tax professionals often require additional information that must be collected from the clients. This process is time consuming, costly, inefficient, and prone to error.

### SUMMARY OF THE INVENTION

In accordance with the present invention, the disadvantages and problems associated with previous tax reporting survey techniques have been substantially reduced or eliminated. In particular, the present invention provides a web-based tax reporting survey for simplified distribution of forms, and the collection, analysis, manipulation and/or storage of information relating to the tax reporting survey. Several built-in processes include database link functionality and automated edit checks.

In accordance with one embodiment of the present invention, a method for calculating tax credit information includes providing an on-line reporting form to a plurality of users. Information regarding allocation of financial resources regarding one or more projects associated with more than one of the plurality of users is collected from the more than one of the plurality of users. Tax credit information is calculated based upon the allocation of financial resources regarding the one or more projects.

In accordance with another embodiment, at least some of the information collected from the more than one of the plurality of users is automatically verified, while the information is being input by the more than one of the plurality of users. The automatic verification may include comparing the information with stored data within one or more databases.

In accordance with yet another embodiment, one or more edit checks are performed regarding the information. The edit checks may include verifying that related data fields do not contain inconsistent data.

Technical advantages of particular embodiments of the present invention include a web-based tax reporting survey. Surveys are distributed and collected at one or more servers. This reduces the amount of time and resources required for the distribution of forms, as well as the collection, analysis, manipulation, and/or storage of information relating to the tax-reporting survey.

Another technical advantage of particular embodiments of the present invention includes database links incorporated into an on-line reporting survey. This allows for verification of specific information provided by a client, or employee, by accessing data contained within one or more databases using the database link. Accordingly, errors in inputting information to the tax-reporting survey are identified while a user is completing the tax-reporting survey. This reduces the amount of time and resources dedicated to correction and/or follow-up with the users for additional information.

Still another technical advantage of particular embodiments of the present invention include automated edit checks performed while the user is completing the tax-reporting survey. The edit checks include verification that related data fields do not contain inconsistent data. This allows for automated and simplified identification of errors while the tax-reporting survey is being completed by the user.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates one embodiment of a communication system incorporating teachings of the present invention;

FIG. 2 illustrates a method for calculating tax credit information, in accordance with a particular embodiment of the present invention;

FIG. 3 illustrates a method for collecting research and experimentation tax credit information, in accordance with another embodiment of the present invention;

FIG. 4 illustrates a tax survey form cover page, in accordance with a particular embodiment of the present invention;

FIG. 5 illustrates a cost center identification form, in accordance with a particular embodiment of the present invention;

FIG. 6 illustrates a reporting questionnaire, in accordance with a particular embodiment of the present invention; and

FIG. 7 illustrates a questionnaire regarding the qualification of cost center activities, in accordance with a particular embodiment of the present invention.

### DETAILED DESCRIPTION OF THE INVENTION

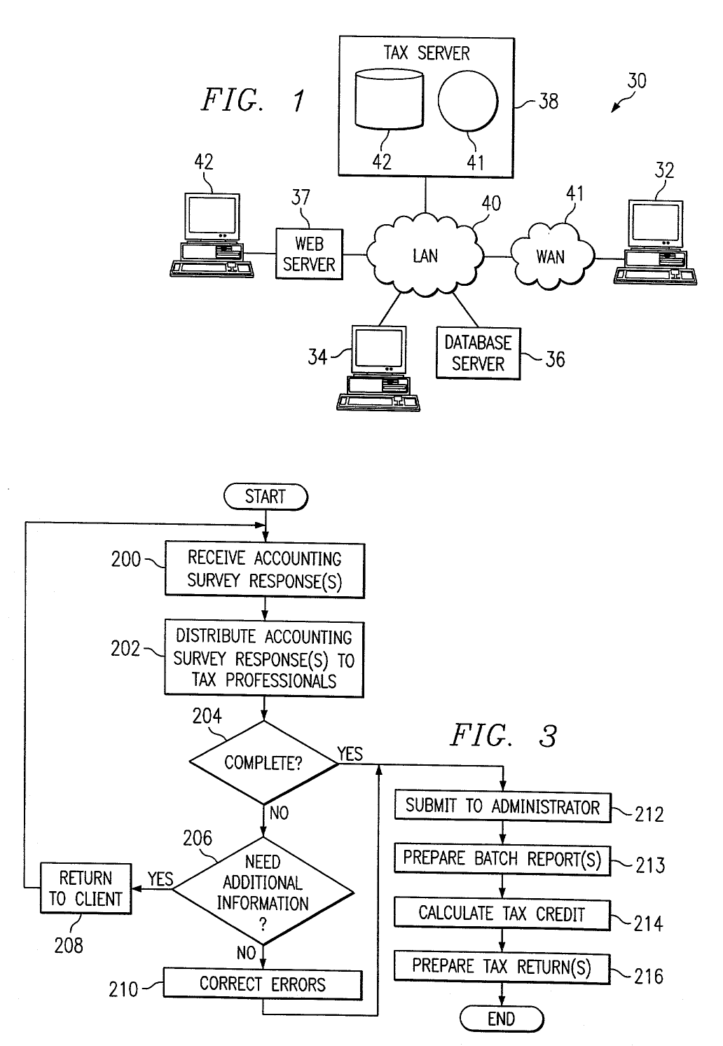

FIG. 1 illustrates a communication system 30, which incorporates aspects of the present invention. A plurality of clients 32, 34 are coupled with servers 3638 using one or more communication networks 40, 41. A computing device 42 provides an administrator with access to a web server 37. In accordance with a particular embodiment of the present invention, web server 37 may be configured to automatically distribute, collect, analyze and/or store a plurality of tax reporting surveys received from clients 32, 34. Accordingly, such processes are streamlined and at least partially automated in order to minimize the labor and resources required for a widespread tax reporting program. Furthermore, the accuracy of information collected from clients (or employees) may be verified to increase the overall value of the tax credit and verify compliance with tax rules and regulations.

In accordance with a particular embodiment, the present invention provides a web browser-based survey utilizing client and server side scripting technology for navigation, field validation and interaction. The survey is user-friendly for cost center managers and/or employees completing the document. Tax reporting surveys may be completed on-line, and submitted directly to an administrator or tax department. The on-line survey may be linked to an SQL database which contains general ledger information that populates specific fields related to cost center man-months and outside labor expenses. This link helps ensure that actual general ledger amounts are correct. The server is also linked to a tax department database 42 to reduce input and administrative time required by tax department employees.

As the client, employee or cost center manager completes and submits the tax survey, specific data fields are automatically populated. There are also several built in edit checks to ensure that all required fields are properly completed. Accordingly, follow-up time conducted by tax department employees is significantly reduced.

Batch reports may also be generated by tax server 38. Batch reports allow isolated data collected from one or more tax surveys to be viewed for analysis by tax employees. Similarly, hard-copy printouts of all surveys collected on-line may be produced for review by tax personnel, and/or used as backup documentation to tax return documents and reports.

In the illustrated embodiment, communication network 40 is a local area network that enables communication between client 34 and servers 36-38. Communication network 41 is a wide area network (WAN) that couples client 32 with communication network 40. WAN 41 enables communication between a plurality of clients distributed across multiple cities and geographic regions.

Although specific communication networks 40 and 41 are illustrated in FIG. 1, the term “communication network” should be interpreted as generically defining any network capable of transmitting data and/or messages. Either of networks 40 or 41 of the illustrated embodiment could be local area networks (LANs), (WANs), global distributed networks such as the Internet, Intranet, Extranet, or any other form of wireless or wireline communication network, within the teachings of the present invention.

Communication network 40 may be protected from unauthorized access using encryption and/or security, firewalls, passwords, etc. In a similar manner, any particular component coupled with network 40 may be protected from unauthorized access. For example, access to web server 37 and/or tax server 38 may be limited to those managers or employees whose job functions require such access.

Clients 32, 34 and computing device 42 may be any combination of hardware, software, and/or embedded logic that provide communication services to a user. For example, clients 32, 34 may include a telephone, a computer running telephony software, a video monitor, or any other communication hardware, software, and/or encoded logic that supports communication of media using communication network 40.

Servers 36-38 may also include any combination of hardware, software, and/or embedded logic, and may be centrally located within a particular component of communication system 30, or distributed throughout one or more network components of communications system 30. In the illustrated embodiment, for example, tax server 38 includes a processor 41 and database 42. Processor 41 may be a microprocessor, controller, or any other suitable computing device or resource. Database 42 may include any memory module and may take the form of volatile or non-volatile memory including, without limitation, magnetic media, optical media, random access memory (RAM), read-only memory (ROM), removable media, or any other suitable local or memory component. It should be recognized that any one or more of clients 32, 34, computing device 42, and/or servers 36-38 may include any number of configuration of processors or memory, within the teachings of the present invention. Such components are operable to perform the features and functionality described herein with regard to the distribution, collection, analysis, storage, and/or manipulation of data collected from a plurality of clients regarding tax reporting surveys.

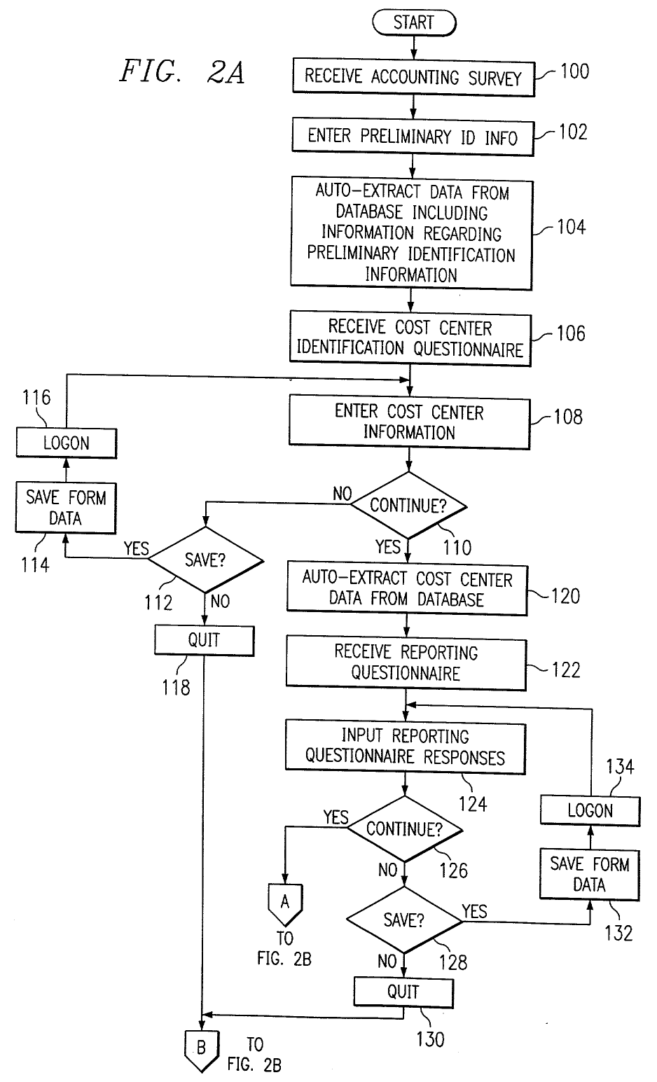

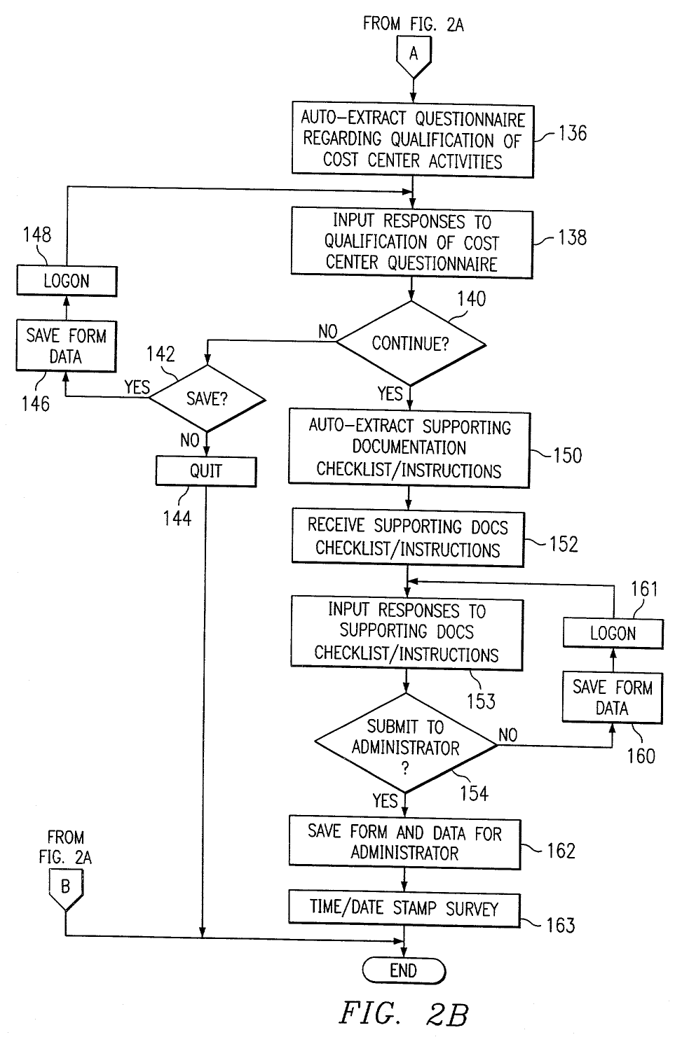

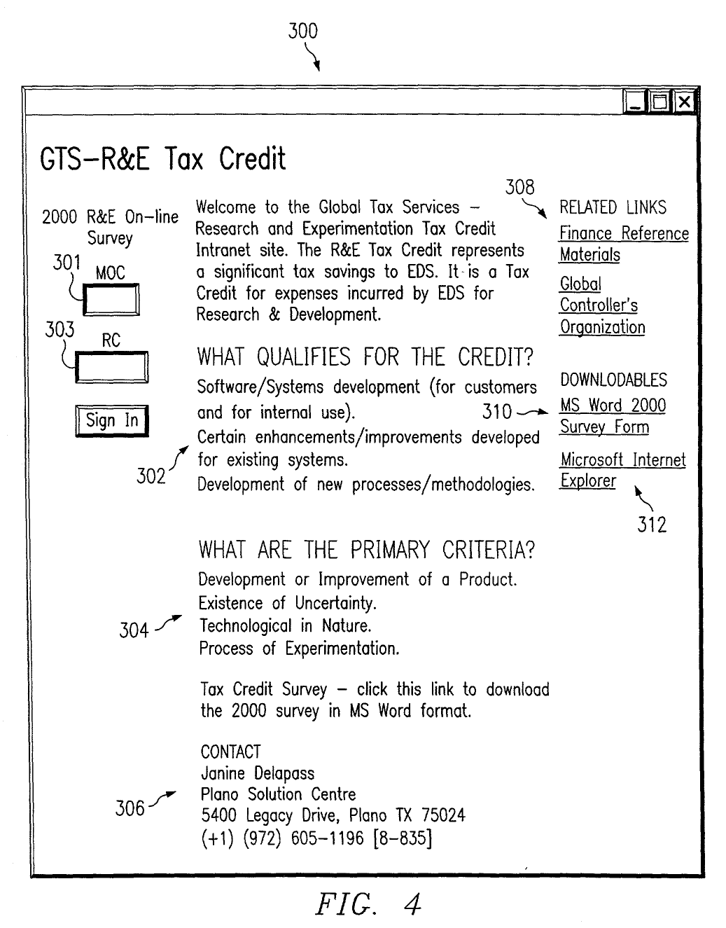

FIG. 2 illustrates a method for calculating tax credit information, in accordance with a particular embodiment of the present invention. The method begins at step 100 where a user, or client, receives an accounting survey. The accounting survey may include documents such as those illustrated and described in FIGS. 4-7. There are several methods for the distribution of accounting surveys available. For example, an administrator may identify appropriate clients to receive the accounting survey and selectively distribute the surveys using electronic mail. Such electronic mail messages may include hyperlinks to one or more network servers which collect, manipulate, calculate, report and/or store information received from the administrator or the client. In another embodiment, messages may be distributed to the appropriate clients, inviting such clients to log on to a network server, in order to receive an accounting survey. Alternatively, accounting surveys may be made continuously available on line, for at least a predetermined period of time, in which clients may access and complete the accounting surveys. After receiving the accounting survey, the client has the opportunity to interactively complete the survey, during which time the server accesses one or more databases to retrieve data based, at least in part, upon information received from the client.

At step 102, the client enters preliminary identification information. For example, this information may be provided at data fields 301 and/or 303 of FIG. 4. Such information identifies the individual client and/or a particular group, program, or cost center associated with the client. Using this information, a network server is able to automatically extract data from the database with specific information regarding the preliminary identification information, at step 104.

An accounting survey cover page 300 (FIG. 4) will also include instructions used for filling out the survey. For example, the accounting survey cover page may describe qualifications for a research and experimentation tax credit at text field 302. This may include software/systems development (for customers and for internal), certain enhancements/improvements developed for existing systems, and/or development of new processes methodologies. The accounting survey cover page may also discuss primary criteria at text field 304. For example, primary criteria may include development or improvement of a product, existence of uncertainty, technological in nature, and/or process of experimentation. On-line support and contact information for the administrator may also be provided, at text field 306. At this point, the client is invited to sign-in, in order to complete the accounting survey, using the financial identifiers described above. Hyperlinks may also be provided to reference material at link 308 or a list of frequently asked questions which may assist the client in completing the accounting survey. Such hyperlinks may also include downloadable software or survey form links 310 and 312 in various software types and versions, in order to suit the particular aptitude of the client.

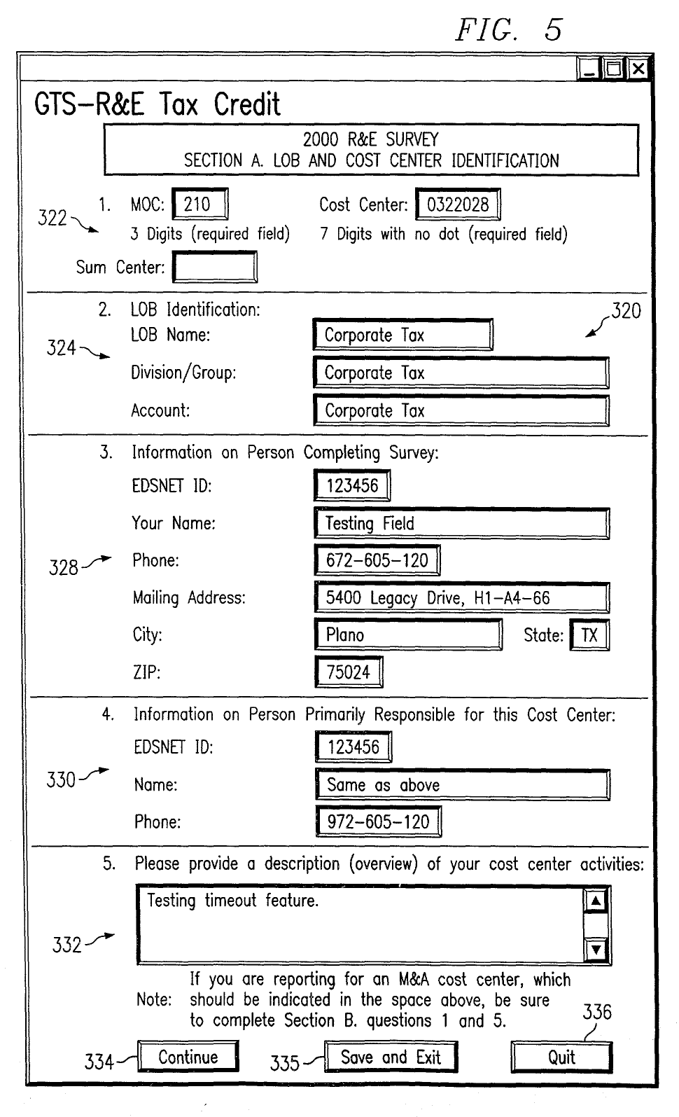

After receiving the financial identifier, the server provides, to the client, a cost center identification questionnaire 320 (FIG. 5), tailored to the particular client and/or associated with the financial identifier, at step 106. The cost center ID questionnaire 320 is populated with the data extracted at step 104. For example, the cost center identification questionnaire may be automatically populated with information including identification numbers for the cost center field 322. Field 324 may be filled in by the user and indicate a particular line of business. A particular example of a line of business may include corporate tax.

The cost center identification questionnaire may also include various fields to be completed by the client. Such fields may include an employee identification number, name, telephone number, mailing address, and/or other information associated with the client that is completing the survey. Such information is illustrated at data/text field 328. Additionally, the cost center identification questionnaire may request specific information regarding the individual(s) primarily responsible for the particular cost center, for example, the cost center manager, at data/text field 330. The client may also be provided with a data field suitable for the client to provide a brief description or overview of the cost center activities, at text field 332.

After the client enters cost center information, and other information associated with the cost center ID questionnaire at step 108, the client is given the option to continue at step 110. If the client elects not to continue, the client is given the opportunity to save the worksheet, including any information input by the client up to that point, at step 112. If the client elects to save the form at step 112, a form is saved with the data previously input by the client at step 114. The form data is saved until the client attempts to log on again at step 116. When the client logs on in the future, the client is provided with the cost center ID questionnaire, including the information previously input by the client, and the client is allowed to continue to enter cost center information at step 108.

If the client elects not to save the cost center identification questionnaire, including the information previously input by the client, at step 112, then the system quits the operation, and the method ends, at step 118. These options are provided to the user via selection bars 334-336 (FIG. 5).

While the client is filling in information on the cost center ID questionnaire, network server 37 monitors the information input by the client and performs a series of edit checks. Such edit checks verify that appropriate information is being entered by the client. For example, network server 37 may be linked with a database at one or more of servers 36-38, that includes information regarding employee identification numbers and names. If the client enters an erroneous name or identification number for the individual completing the survey, or for the person primarily responsible for the cost center, then an error message is generated. At this time, the client is invited to correct such errors by a message automatically generated by server 37.

Additionally, network server 37 may use some of the information provided by the client in order to populate cost center identification questionnaire 320 with additional information. In a particular embodiment, network server 37 may use a cost center identification number provided by the client at field 322 in order to determine information about the line of business of the cost center at field 324. In this manner, the network server may populate a data field which describes the name of the line of business with the specific line of business associated with the cost center identification number input by the client. Similarly, the network server may populate data fields with various information regarding the person completing the survey using the employee number or employee name input by the client.

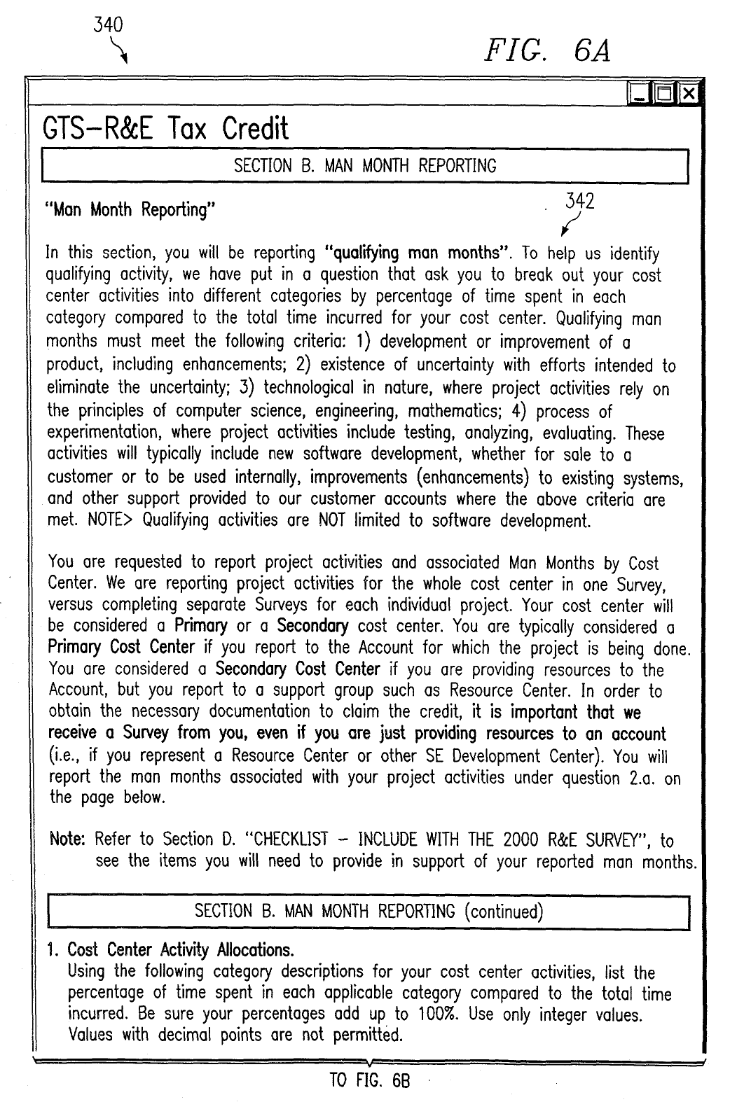

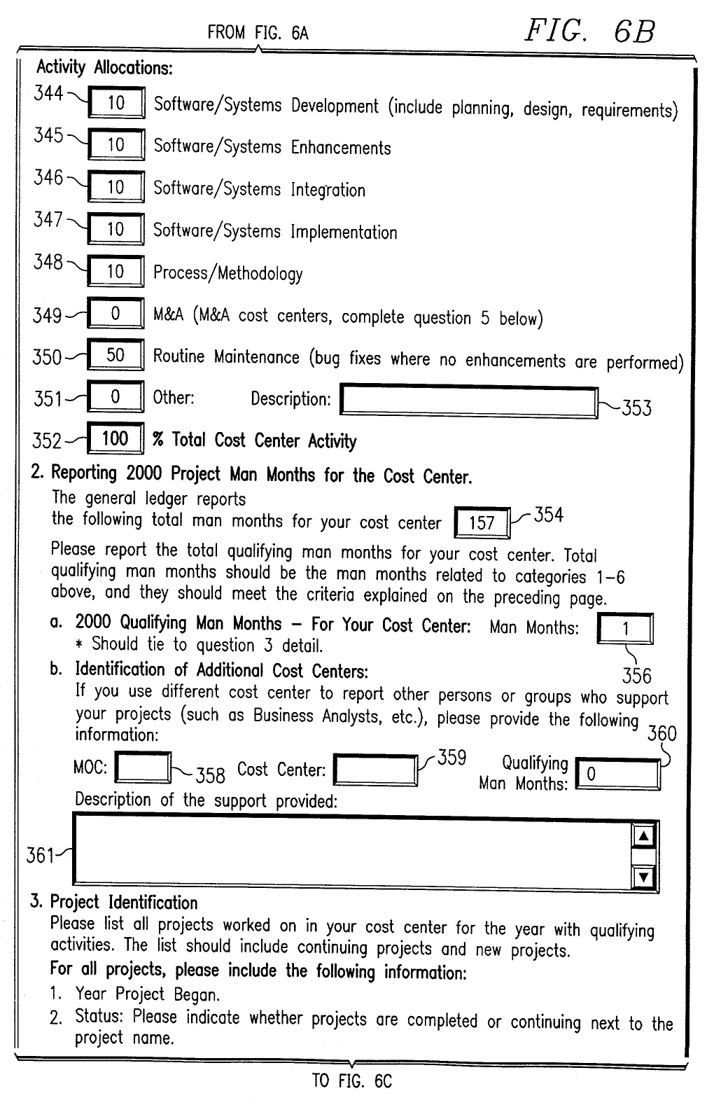

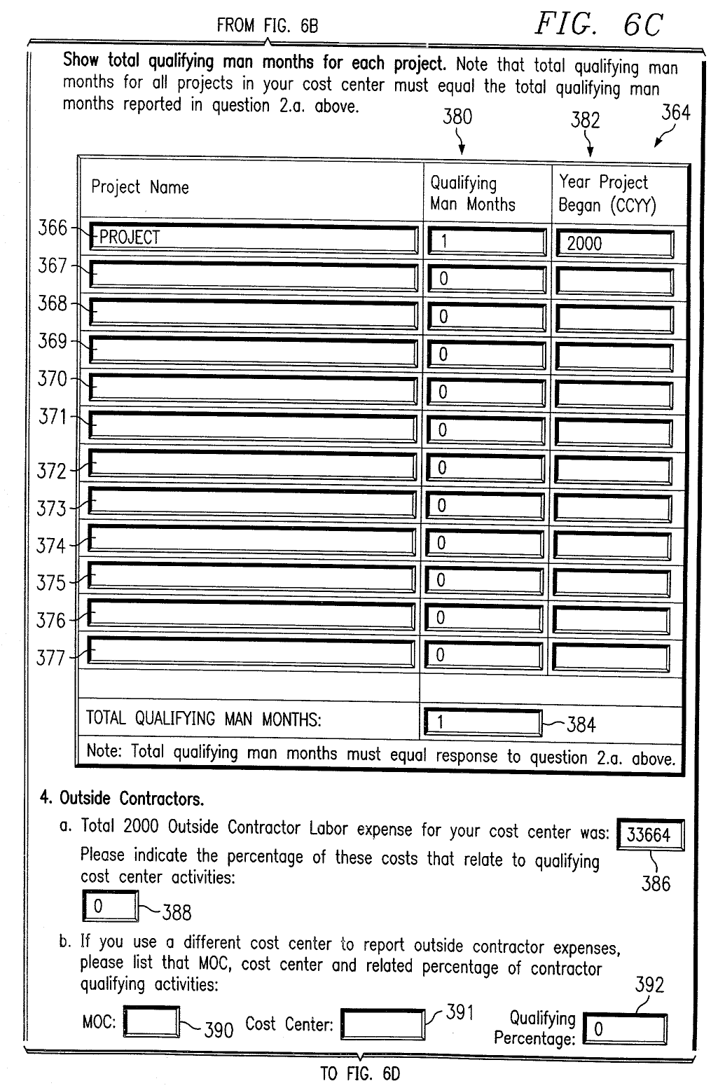

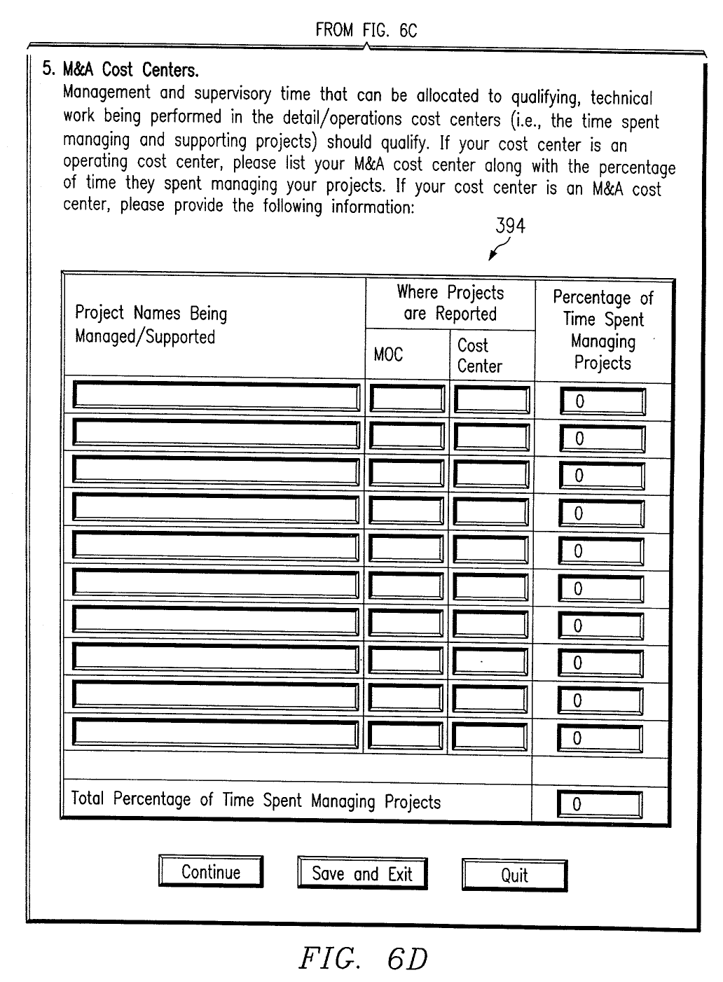

If the client elects to continue with the accounting survey at step 110, network server 37 automatically extracts cost center data from a database in order to populate particular data fields associated with a reporting questionnaire 340 (FIG. 6) at step 120, and the reporting questionnaire 340 is displayed to the client at step 122. The reporting questionnaire may include information on the format for reporting periods of time, and/or sums of money which qualify for the research and experimentation tax credit for example, at text field 342. In a particular embodiment, the period of time may be referred to as “qualifying man-months.”

The client is interactively allowed to fill in information, and may receive specific instructions for each data field to be completed by the client, at step 124. Particular data fields may include values, identified in percentages, identifying the specific allocation of activities within the particular project or cost center. For example, the client may be asked to assign a particular percent to more than one activities performed in the cost center. Data fields 344-351 for such values represent activities including software/systems development (including planning, design, requirements), software/systems enhancements, software/systems integration, software/systems implementation, process/methodology, M&A, routine maintenance (bug fixes where no enhancements are performed), and/or other. For “other” activities, the client may be invited to input a specific description of such other activities at text field 353.

For each of the eight activities described above, the client is asked to allocate the percentage of time spent on each activity. The sum of the eight data fields 344-351 input by the client must equal one hundred percent, and is represented at data field 352. If network server 37 determines that data field 352 does not equal one hundred percent, an error message may be generated, and the client asked to reallocate such percentages 344-351. Ultimately, the percentages of activity allocations may be used by network server 37 in order to compute the total research and experimentation tax credit available. However, the activities and their associated descriptions may also be viewed later by the administrator or a tax professional, in order to determine whether or not the activity qualifies for the research and experimentation tax credit.

The reporting questionnaire also includes a data field 354 representing the total man-months reported in a general ledger, maintained at the database. Network server 37 automatically populates this data field 354 with the value reported in the general ledger regarding the total man-months for the cost center associated with the client's employee number and/or cost center identification. This value provides a multiplier to be used by the client in computing the total man-months, wherein the percentage of man-hours reported in the activity allocations may be used to determine qualifying man-months.

An additional data field 356 is provided which allows the client to report the total qualifying man-months for a given period of time, for example, during a fiscal and/or calendar year in question. Additional data fields 358-360 may be provided to allow the client to identify additional cost centers from which other persons or groups have supported the projects identified by the client. Therefore, cost center identification data fields 358 and 359 and qualifying man-months data field is 360 are provided to allow the client to allocate time that other persons or groups used to support the projects being described in the accounting survey. A text/data field 361 may also be provided, in which the client is invited to provide a written description of the support provided by persons or groups dedicated to other cost centers.

In order to provide backup support for the total qualifying man-months provided by the client, a table 364 is provided which includes data fields in which the client can describe each project. A plurality of data fields 366-377 are provided wherein the client can identify the name of one or more specific projects. Another column 380 is provided which has a plurality of data fields in which the client can indicate the corresponding number of man-months associated with each project. A third column 382 may be provided which includes a plurality of data fields wherein the client can identify the year in which the corresponding project began.

Table 364 includes a data field 384 which represents the total number of qualifying man-months from all the projects 366-377 listed within the table. The total number of qualifying man-months reported within data field 384 must correspond to the total qualifying man-months reported by the client at data field 356. Network server 37 automatically verifies that the total number of qualifying man-months from table 364 corresponds to the total number of qualifying man-months reported by the client at data field 384. If the number of qualifying man-months in the table does not equal the total qualifying man-months reported by the client above, an error message is generated and the client is invited to correct the table and/or the number of qualifying man-months reported above.

Additional data fields may be provided in which the client may report the number of qualifying man-months associated with outside contract labor expenses. For example, a first data field 386 may be provided which indicates the total outside contract labor expense for the year in question. This value is automatically retrieved from the database by the network server. In another data field 388, the client is invited to indicate the percentage of outside contract labor expense costs that were dedicated to cost center activities which qualify for the research and experimentation tax credit.

Additional data fields 390-392 may be provided in which the client can identify additional cost centers from which outside contract labor expenses were dedicated to projects being reported by the client. Such data fields may include a financial identifier (390), or cost center indicator (391) as well as a qualifying percentage (392) which was dedicated to activities which qualify for the research and experimentation tax credit. Another table 394 is provided in which management and supervisory time can be allocated to qualifying (tax-credit) technical work being performed in particular cost centers.

At this point, the client is given the option to continue at step 126, save the form with the data already reported by the client, at step 128, or quit, at step 130. The operation of these options is similar to those of the continue, save, or quit options associated with steps 110, 112, and 118, respectively. If the client elects to save the form, the network server automatically saves the form along with any data automatically input by the network server and/or input by the client up to that point, at step 132. This form and the associated data is saved until the client logs on again at step 134. When the client logs on, the form along with any data previously automatically input by the network server or input by the client is presented to the client, and the client is given the option to continue to input reported questionnaire responses at step 124.

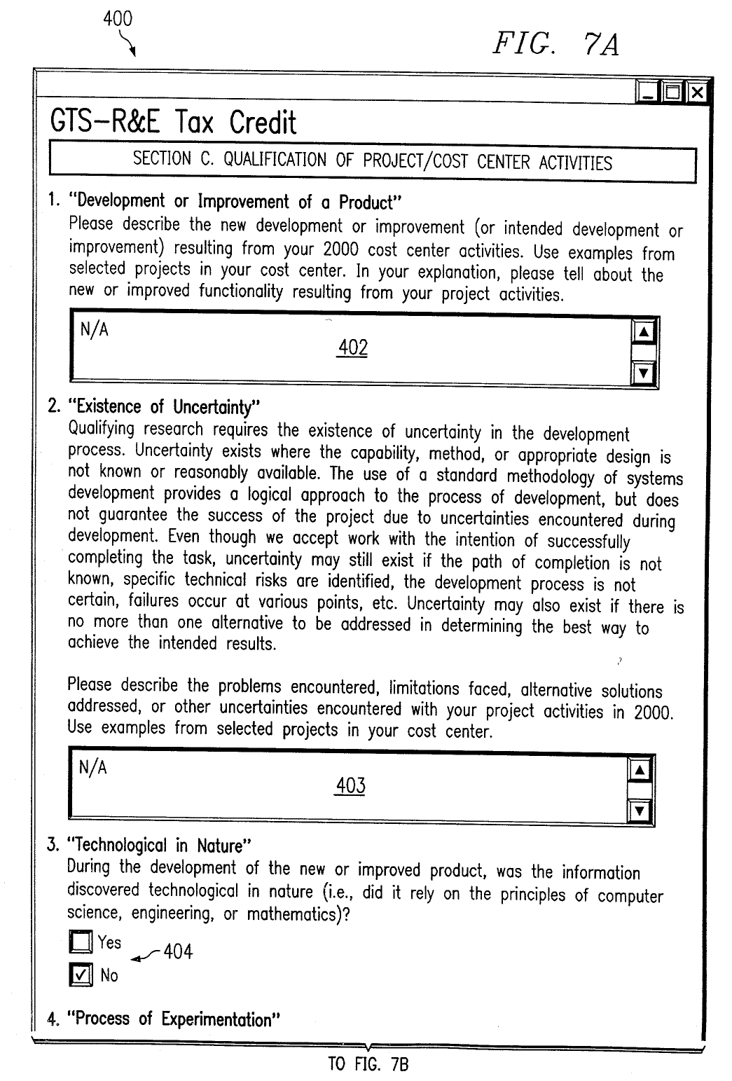

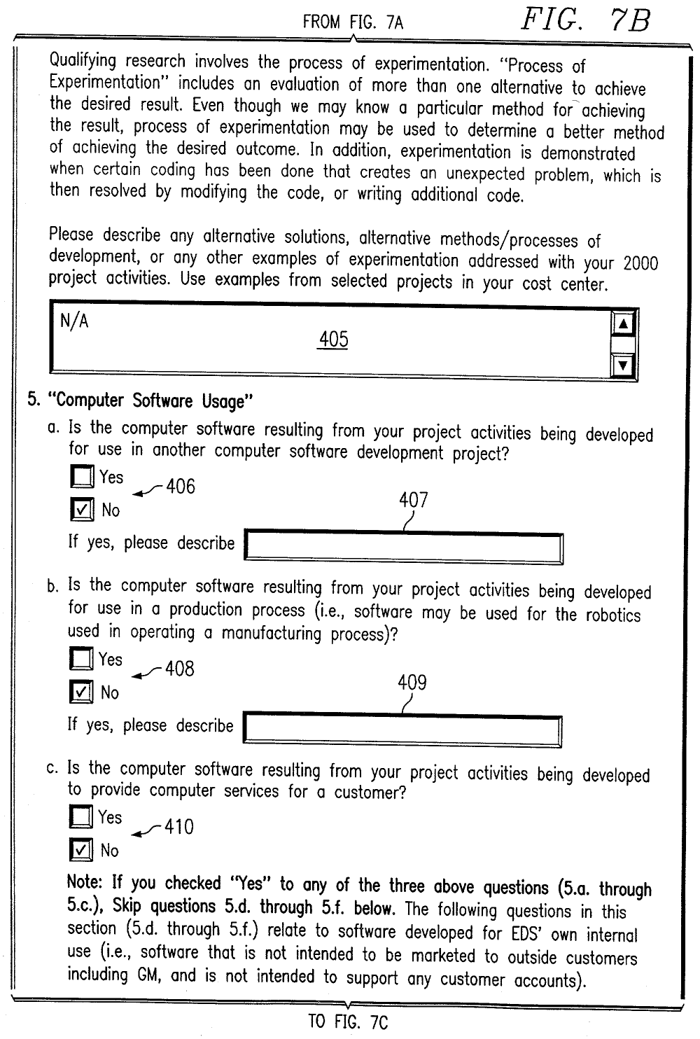

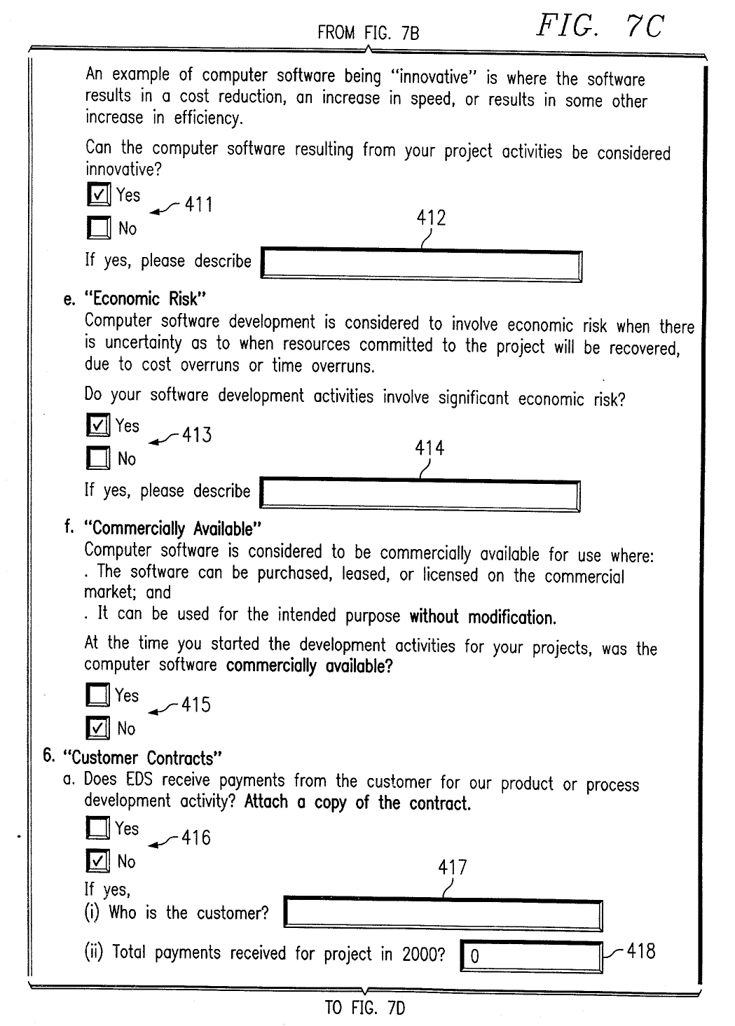

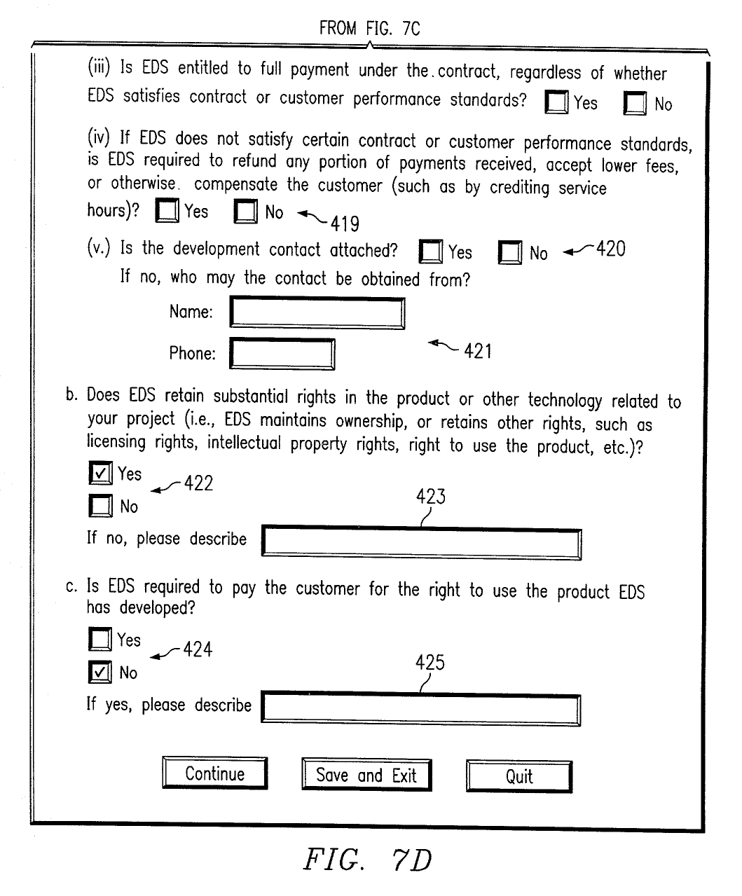

If the client elects to quit, the method ends, and no forms or data are saved. Alternatively, if the client elects to continue at step 126, the network server automatically extracts a questionnaire 400 (FIG. 7) regarding the qualification of cost center activities. The particular form extracted by the network server at this step 136 may be related to and/or derived from the specific answers and/or values of data fields of previously input data regarding the reporting questionnaire, the cost center ID questionnaire, or any other portion of accounting survey 300.

The client interactively inputs responses to the cost center questionnaire 400 at step 138. The qualification of project/cost center activities questionnaire includes a data field 402 in which the client is invited to describe new developments or improvements (or intended developments or improvements) resulting from qualifying cost center activities. The client may also be invited to provide examples from selected projects in the cost center. This data field 402 may also be used for the client to describe any new or improved functionality which resulted from the qualifying project activities.

Another text/data field 403 may be provided in which the client can describe the existence of uncertainty in the development process. A brief description and/or examples indicating the definition of uncertainty as it relates to the research and experimentation tax credit survey may also be provided.

Additional data fields and/or text fields 404-425 may be provided in which the client may describe and/or provide specific examples regarding whether or not the development of the new or improved product was technological in nature, involved the process of experimentation, involved computer software usage, involved innovation, involved economic risk, and/or was commercially available. Such data and text fields may include yes or no options for the client, as well as text fields in which the client may describe their answers.

Another set of questions related to “customer contracts” may be provided in which the client can describe whether or not payments were received from customers for the product or process during development activity. This field is included because the amount of money and circumstances under which the money is received from a customer may effect a company's overall research and experimentation tax credit.

Additional information regarding any funds received from a customer may also be input into a variety of data fields 416-425, by the client. For example, a data field 417 is provided in which the client is invited to identify the name of the customer from which the payments were received. Similarly, a data field 418 is provided in which the client may identify the amount of funds or payments received from the customer during the year in question. The client may also be asked to answer several questions with a response of yes or no. Such questions are directed at assisting the administrator in determining whether or not such payments received from customers will have an impact on the overall amount of the research and experimentation tax credit due to the company.

For example, the client may be asked whether or not the company is entitled to full payment under the contract with the customer, regardless of whether the company satisfies contract or customer performance standards. Similarly, the client may be asked whether the company is required to refund any portion of payments received, except lower fees, or otherwise compensate the customer (such as by crediting service hours), if the company does not satisfy certain contract or customer performance standards. Where a development contract with a customer exists, the client is asked to attach a copy in order for the administrator to utilize it during review in order to determine its impact, if any, upon the research and experimentation tax credit due. If the client is unable to attach the contract, data fields are provided in which the client may include contact information (e.g., name, phone number), for a person knowledgeable about the contract.

Additional information may be solicited from the client regarding intellectual property and/or other rights regarding technology or products related to the project. For example, the client may be asked whether or not the company retains substantial rights in the product or other technology related to the project (i.e., the company maintains ownership, or retains other rights, such as licensing rights, intellectual property rights, and/or rights to use the product, etc.). If it is determined that the company does not retain rights in the product or other related technology referred to above, the client is provided a data field in which a brief description regarding the rights in such product or other technology related to the project. In the illustrated embodiment, the client is also asked if the company is required to pay the customer for the right to use the product, which the company has developed. If it is determined that the company is required to pay the customer, a data field may be provided in which the client describes the circumstances and/or amount regarding the requirement of the company to pay the customer.

At this point, the client is given the option to continue at step 140, save at step 142, or quit at step 144. These options function similarly to the same options provided above, for example, steps 110, 112, and 118. If the client elects to save the form, the form is saved along with any data input by the client prior to saving, at step 146. Such data is saved until the client logs on again at step 148. When the client logs on, they are directed to step 138, where the client may continue to input responses to qualification of cost center questionnaire. If the client elects to quit, the method ends. However, if the client elects to continue, the network server automatically extracts data regarding supporting documentation checklists/instructions, at step 150.

The data extracted by the network server at this step may be specific to information input by the client at previous steps. For example, the network server may compile a list of supporting documentation appropriate to responses received from the client at previous steps. In one example, if the client indicated customer contracts associated with the project existed, and/or may have an impact on the total amount of the research and experimentation tax credit at step 138, the supporting documentation checklist may include an item requesting submission of the customer contract. Similarly, the client may be asked to provide copies of any other documentation which may assist the administrator in the evaluation of the project, with regards to the total amount of research and experimentation tax credit available to the company.

At step 152, the client receives the supporting documentation checklist/instructions. This supporting documentation checklist/instructions includes data and/or information which was automatically extracted by the network server at step 150. In one embodiment, the client may receive a list of documents which should be submitted as supporting documentation regarding the project and the overall research and experimentation tax credit. Instructions regarding which documents to include with the submission, where to find such documents, what form to submit the documents in, and any other information which may be helpful to the administrator in evaluating the overall research and experimentation tax credit may also be provided on the supporting documentation checklist/instructions page. The client may respond to questions regarding the supporting documents checklist/instructions, at step 153. For example, the client may indicate which documents she is including, or attach electronic versions of the documents (or hyperlinks thereto).

Finally, the client is given the option to submit the accounting survey form to the administrator at step 154, or save the form at step 160. If the client elects to save the form at step 160, the form, including all data input by the client up to that point. This information is stored until the client logs on again at step 161, and continues to input responses at step 153. If the client elects to submit the accounting survey at step 154, the entire survey, including all data automatically entered by the network server and/or the client is saved for later review by the administrator at step 162, and time/date stamped at step 163.

With regard to the illustrated embodiment of FIG. 2, the method ends at this point. However, additional steps regarding the manipulation, storage and/or presentation of the data and forms associated with the accounting survey will be described in more detail with regard to FIG. 3.

FIG. 3 illustrates a method for collecting research and experimentation tax credit information, in accordance with a particular embodiment of the present invention. The method begins at step 200 where one or more accounting survey responses are received from one or more clients. The accounting survey responses may be received at a central network server, or at a plurality of network servers which are accessible by an administrator. In accordance with a particular embodiment, each time an accounting survey response is received at a network server, the administrator is notified of such receipt. The notification may take many forms, including electronic mail or an entry upon a log which tracks the number and identification number regarding accounting survey responses received.

At step 202, the accounting survey responses are distributed to one or more tax professionals, for a compliance review. The process of distributing accounting surveys to tax professionals for review may be done automatically by the network server. For example, the network server may distribute particular completed accounting survey responses to one or more particular tax professionals based upon information contained within the completed accounting survey response. Indicators which may be used to determine which tax professional should review a particular completed accounting survey response includes financial identifiers which may indicate the particular project involved, the particular cost center involved and/or the particular department involved. Therefore, tax professionals with a particular expertise in a certain area may be selected to review completed accounting survey responses generated by members from that group, who are related to projects associated with that group or area. Similarly, the total dollar values indicated on the completed accounting survey response may determine which tax professional reviews a particular response.

Certain individuals may be designated to review completed accounting survey responses which include a data field having an amount over a predetermined maximum or minimum. Therefore, particular individuals may be selected to be responsible for reviewing the survey responses associated with higher dollar value projects, or those responses in which relatively higher research and experimentation tax credits are expected.

In an alternative embodiment, the distribution of completed accounting survey responses to tax professionals may be accomplished by a central administrator or manager. In this manner, one or more individuals may control the work flow of a department of tax professionals. In a similar manner, the administrator or manager may review and/or approve particular accounting survey responses, and flag those with apparent inconsistencies In this case, the administrator may review, correct and/or contact the client to obtain additional information in order to correct the accounting survey responses. Alternatively, any accounting survey response with a perceived inconsistency may be distributed to other tax professionals in order to thoroughly review and/or collect additional information from the client.

Along those lines, at step 204 a determination is made as to the completeness of the accounting survey response. This review may be conducted automatically by the network server or this review may be done by hand by the administrator or a tax professional. In many circumstances, it is contemplated that the review will include both automatic checks and edits, and at least a cursory review by a manager or administrator.

As previously discussed, many automatic edits and checks are performed upon the data and information being input by the client as the information is being input. Additionally, checks and edits are accomplished as the client moves from page to page throughout the accounting survey. This preliminary, automatic check by the network server eliminates easily identifiable problems typically encountered in filling out such forms. However, many inconsistencies, errors and/or duplication of work may only be identified centrally, after all or at least many accounting survey responses are received. After the network server collects information regarding several accounting survey responses, such information can be stored, manipulated and/or accessed by other network components or individuals. Many errors and inconsistencies will be more easily identifiable at this stage of review, at step 204.

If it is determined that the accounting survey response is not complete, a determination must be made whether or not additional information from the client is needed, at step 206. If additional information is needed from the client in order to confirm, complete or verify the accuracy of the accounting survey response, the accounting survey response may be returned to the client in order to collect such information at step 208. At this step, the client is invited to provide additional information to help in the evaluation of the accounting survey response. When the client has completed the requested information and/or provided additional supporting documentation, the accounting survey may be resubmitted to the administrator, tax professional, or to the network server, for example, at step 200.

If the administrator or tax professional does not need additional information from the client, that individual may be able to reconcile, complete or provide additional information necessary to complete the accounting survey response at step 210. If this is the case, after such errors are corrected, the completed and verified accounting survey response is submitted to the administrator at step 212. Similarly, if it is determined that no additional information is needed and the accounting survey response is complete at step 204, the completed survey response will be submitted to the administrator at step 212.

After the completed accounting survey response is submitted to the administrator at 212, various methods are available to store, manipulate, verify and/or calculate various values and statistics associated with the accounting survey responses. For example, the network administrator may calculate a running total of the research and experimentation tax credit currently available, based upon the accounting survey responses received to-date, at step 214.

The information collected from completed accounting survey responses may be used in order to prepare batch reports at step 213. Batch reports may be run by the administrator, tax professionals and/or managers in order to receive up-to-date information regarding responses received to-date. In one embodiment, the batch reports may be used to identify which accounting surveys have been received over a predetermined period of time. For example, this information may be used in order to determine which accounting survey responses still need to be reviewed by an administrator or tax professional. The batch reports may also be used to collect, manipulate and/or calculate various values or running totals of values represented within the accounting survey responses received during a specific time frame or during the entire year to-date. Similarly, such reports can be run for information from previous years for comparative purposes with information received during the present year.

A tax return prepared in a form acceptable to the Internal Revenue Service (IRS) may be prepared at step 216, using the information from some or all of the completed accounting survey responses received up to that point in time. The tax return will provide information regarding the total research and experimentation tax credit available at that time, and also many other statistics regarding: (i) the overall value of projects, (ii) percentage of qualifying man-hours associated with individual projects or the aggregate of all projects, (iii) comparative data from the previous tax year or other period of time, and/or (iv) other information which may be important to the administrator or management of the company or organization.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for calculating tax credit information, comprising:
providing an on-line reporting form to a plurality of users;
collecting from more than one of the plurality of users, information regarding allocation of financial resources regarding one or more projects associated with the more than one of the plurality of users; and
calculating tax credit information based upon the allocation of financial resources regarding the one or more projects.

2. The method of claim 1, wherein the on-line reporting form includes database links to one or more databases, and further comprising:
automatically verifying at least some of the information collected from the more than one of the plurality of users, while the information is being input; and
wherein the automatic verification includes comparing the information with stored data within one or more databases.

3. The method of claim 1, wherein the more than one of the plurality of users input data to a plurality of data fields, and further comprising:
performing one or more edit checks regarding the information; and
wherein the edit checks include verifying that related data fields of a plurality of data fields associated with the reporting form do not contain inconsistent data.

4. The method of claim 1, wherein the on-line reporting form utilizes client and server side scripting technology for at least one of navigation, field validation and interaction.

5. The method of claim 2, wherein the database includes an SQL database and further comprising automatically populating a plurality of data fields associated with the on-line reporting form using data retrieved from the SQL database.

6. The method of claim 5, wherein the data retrieved from the SQL database relates to cost center man-months of time dedicated to the one or more projects.

7. The method of claim 5, wherein the data retrieved from the SQL database relates to outside labor expenses dedicated to the one or more projects.

8. The method of claim 1, further comprising batch producing reports including summaries of at least some of the information collected from the more than one of the plurality of users.

9. The method of claim 1, further comprising batch producing hardcopy printouts corresponding to the on-line reporting form.

10. The method of claim 1, further comprising:
automatically generating a list of requested backup documentation from the more than one of the plurality of users; and
transmitting the list to the more than one of the plurality of users.

11. The method of claim 1, further comprising:
receiving, from an administrator, a report request for a specified time frame regarding the information collected from the more than one of the plurality of users; and
generating a report covering the specified time frame.

12. The method of claim 1, further comprising calculating a tax credit amount based upon the allocation of financial resources regarding the one or more projects.

13. The method of claim 1, further comprising generating a tax return form indicating a cumulative tax credit amount, wherein the tax return form is in compliance with Internal Revenue Service codes.

14. A system for calculating tax credit information, comprising:
a server being operable to collect, from more than one of the plurality of users, information regarding the allocation of financial resources regarding one or more projects associated with the more than one of the plurality of users; and
the server including a processor being operable to calculate tax credit information based upon the allocation of financial resources regarding the one or more projects.

15. The system of claim 14, wherein the on-line reporting form includes database links to one or more databases, and further comprising:
a database including stored data; and
the processor being further operable to access the database and automatically verify at least some of the information collected from the more than one of the plurality of users, while the information is being input.

16. The system of claim 14, wherein the more than one of the plurality of users input data to a plurality of data fields, and the processor being further operable to perform one or more edit checks regarding the information; and
wherein the edit checks include verifying that related data fields of the plurality of data fields associated with the reporting form do not contain inconsistent data.

17. The system of claim 15, wherein the database includes an SQL database and further comprising automatically populating a plurality of data fields associated with the on-line reporting form using data retrieved from the SQL database.

18. Logic encoded in media for calculating tax credit information, the logic operable to perform the following steps:
provide an on-line reporting form to a plurality of users;
collect from more than one of the plurality of users, information regarding allocation of financial resources regarding one or more projects associated with the more than one of the plurality of users; and
calculate tax credit information based upon the allocation of financial resources regarding the one or more projects.

19. The logic encoded in media of claim 18, wherein the on-line reporting form includes database links to one or more databases, and wherein the logic is further operable to:
automatically verify at least some of the information collected from the more than one of the plurality of users, while the information is being input by the more than one of the plurality of users; and
wherein the automatic verification includes comparing the information with stored data within one or more databases.

20. The logic encoded in media of claim 18, wherein the more than one of the plurality of users input data to a plurality of data fields, and wherein the logic is further operable to:
perform one or more edit checks regarding the information; and
wherein the edit checks include verifying that related data fields of the plurality of data fields associated with the reporting form do not contain inconsistent data.

21. The logic encoded in media of claim 19, wherein the database includes an SQL database, and wherein the logic is further operable to automatically populate a plurality of data fields associated with the on-line reporting form using data retrieved from the SQL database.

22. An apparatus for calculating tax credit information, comprising:
means for providing an on-line reporting form to a plurality of users;
means for collecting from more than one of the plurality of users, information regarding allocation of financial resources regarding one or more projects associated with the more than one of the plurality of users; and
means for calculating tax credit information based upon the allocation of financial resources regarding the one or more projects.

23. The apparatus of claim 22, wherein the on-line reporting form includes database links to one or more databases, and further comprising:
means for automatically verifying at least some of the information collected from the more than one of the plurality of users, while the information is being input by the more than one of the plurality of users; and
wherein the automatic verification includes comparing the information with stored data within one or more databases.

24. The apparatus of claim 22, wherein the more than one of the plurality of users input data to a plurality of data fields, and further comprising:
means for performing one or more edit checks regarding the information; and
wherein the edit checks include verifying that related data fields of the plurality of data fields associated with the reporting form do not contain inconsistent data.

25. The apparatus of claim 23, wherein the database includes an SQL database, and further comprising means for automatically populating a plurality of data fields associated with the on-line reporting form using data retrieve from the SQL database.
